(19) United States
(12) Patent Application Publication
(10) Pub. No.: US 2008/0137556 A1
(43) Pub. Date: Jun. 12, 2008

(54) MESH NETWORKING AUTO CONFIGURATION METHOD, VIRTUAL LINK SETTING METHOD, PACKET TRANSMISSION METHOD IN MULTI-HOP WIRELESS LAN, AND TERMINAL THEREOF

(76) Inventors: Jun-Hee PARK, Daejon (KR); Dong-Hee KIM, Daejon (KR); Kyeong-Deok MOON, Daejon (KR); Sung-Woo TAK, Busan (KR); Byoung-Hoon KIM, Gyeongsangnam-do (KR)

Correspondence Address: LADAS & PARRY LLP, 224 SOUTH MICHIGAN AVENUE, SUITE 1600, CHICAGO, IL, 60604, US

(21) Appl. No.: 11/941,424

(22) Filed: Nov. 16, 2007

(30) Foreign Application Priority Data
Dec. 8, 2006 (KR) 10-2006-0125168

(51) Int. Cl. H04L 12/28; G06F 15/177

(52) U.S. Cl. 370/255; 709/220

(57) ABSTRACT

Provided are a mesh networking auto configuration method, a virtual link setting method, and a packet transmission method in a multi-hop wireless local area network (LAN), and a terminal thereof. According to the provided methods and terminal, the mobility and connectivity of a wireless terminal is guaranteed in a multi-hop wireless LAN, and a seamless service can be provided. Also, a wireless terminal can be enabled to operate in a home gateway in a home networking field according to the present invention.

### CROSS-REFERENCE(S) TO RELATED APPLICATIONS

The present invention claims priority of Korean Patent Application No. 10-2006-0125168, filed on Dec. 8, 2006, which is incorporated herein by reference.

### BACKGROUND OF THE INVENTION

1. Field of the Invention

The present invention relates a mesh networking auto configuration method, a virtual link setting method, and a packet transmission method in a multi-hop wireless local area network (LAN), and a terminal thereof.

This work was supported by the IT R&D program for MIC/IITA [2004-S-605, “Development of HD Level Interactive Multimedia Service Technology over Wireless Home Network”].

2. Description of Related Art

An infrastructure based single hop wireless local area network (LAN) according to the related art includes wireless terminals and access points. Since wireless devices communicate with each other through an access point in the infrastructure based single hop wireless LAN, all of the wireless terminals must be located in the coverage range of the access point. If a wireless terminal is located in a dead zone that is the outside of the coverage range, the wireless terminal cannot communicate with an access point. Therefore, the infrastructure based single hop wireless LAN has a problem of limiting the mobility and the connectivity of wireless terminals.

Since all of packets are concentrated at an access point, the bottle neck problem is arisen at the access point. As a result, the performance of each wireless terminal is getting degraded as the number of wireless terminals increases. In the infrastructure based single hop wireless LAN, the network auto configuration is performed by receiving an IP address from a DHCP server. If more than one of DHCP servers are present, there may be serious problem arisen in the entire network. Also, a wireless terminal incapable of directly communicating with the DHCP server cannot be allocated with an IP address.

In order to overcome the program of the conventional infrastructure based single hop wireless LAN, following three schemes were introduced.

As the first introduced scheme, an Ad-hoc based multiple hop wireless networking scheme was introduced.

In the Ad-Hoc based multiple wireless networking scheme, all of wireless terminals in an access point operate as an Ad-Hoc mode, and uses an Ad-Hoc routing method, thereby forming a multi-hop based Ad-Hoc network. In the Ad-Hoc based multiple wireless network, wireless terminals communicate with each other without an access point. Therefore, the bottle neck problem is not arisen at the access point, which is arisen in the infrastructure based single hop wireless network. Also, wireless terminals can communicate with each other through a multi-hop based Ad-Hoc routing method although the wireless terminals are located at a non-communicable area. Therefore, the mobility and the connectivity are not limited.

However, the performance of a medium access control (MAC) layer is constrained in the Ad Hoc network unlike the infrastructure network according to an article by Jinyang Li etc, entitled “Capacity of Ad Hoc Wireless networks” in 7th ACM International Conference on Mobile Computing and Networking, 2001. Due to the performance constraint of the MAC layer, a service limitation problem of an upper application layer is arisen in the Ad Hoc based multiple wireless networking scheme.

As the second introduced scheme, a multiple hop wireless networking scheme using a relay node was introduced.

The multiple hop wireless networking scheme using a relay node is equivalent to the expansion of a wireless terminal's function in an infrastructure based single hop network. That is, a wireless terminal in a coverage range of an access point relays packets from a wireless terminal in a dead zone. Therefore, the limitation of the mobility and the connectivity, which are the problem of the infrastructure based single hop network, can be overcome.

In the multiple hop wireless networking scheme using the relay node, the relay node regularly searches a dead zone and determines whether wireless terminals are present in the dead zone or not. Also, a wireless terminal in the dead zone selects one of relay nodes. After selecting, the selected relay node relays the packets of the wireless terminal in the dead zone. However, the multi-hop wireless networking scheme using a relay node has following problems.

Although the relay node must operate as an infrastructure mode to communicate with an access point, a wireless terminal in a dead zone must operate as Ad Hoc mode to communicate with the relay node. Therefore, there is a large change to interrupt the communication between the relay node and the access point because the relay node regularly changes the operation mode. The relay node cannot relay data of the wireless terminal in the dead zone if the relay node is in the infrastructure mode. Therefore, it is required to synchronize two wireless terminals. Finally, a handoff problem may be arisen when the relay node moves or when the wireless terminal in the dead zone moves.

As the third introduced scheme, a multiple hop wireless networking scheme using a dual wireless interface based relay node was introduced.

In the multiple hop wireless networking scheme using the dual wireless interface based relay node, a relay node includes an infrastructure wireless interface and an Ad Hoc mode wireless interface. The relay node communicates with an access point through the infrastructure wireless interface and relays the data of a wireless terminal in a dead zone through the Ad Hoc wireless interface. Therefore, the mobility and connectivity limitation, which is the problem of the infrastructure based single hop network, can be overcome. However, the multiple hop wireless networking scheme using the dual wireless interface based relay node also has following shortcomings.

The relay node needs to select one of the infrastructure wireless interface and the Ad Hoc wireless interface to relay packets. Therefore, it is required to the relay node to detect whether a destination terminal of a packet is in a coverage range of an access point or in the outside of the coverage arrange. A handoff problem may be also arisen when the relay node moves or when the wireless terminal in the dead zone moves. Since a relay node may change in a wireless network having mobility, it is required to all terminals to perform the function of a relay terminal. Therefore, all of the terminals need to have supplementary wireless interfaces, thereby increasing the cost of a wireless terminal.

### SUMMARY OF THE INVENTION

An embodiment of the present invention is directed to providing a mesh networking auto configuration method in a multi-hop wireless local area network (LAN) for automatically setting an IP address of a wireless terminal in a multi-hop based wireless mesh network.

Another embodiment of the present invention is directed to providing a virtual link setting method in a multi-hop wireless LAN for supporting the mobility and connectivity of a wireless terminal in a multi-hop wireless network.

Still another embodiment of the present invention is directed to providing a packet transmission method in a multi-hop wireless LAN for forwarding packets through a virtual link based mesh routing method.

Another embodiment of the present invention is directed to providing a multi-hop based wireless terminal for setting a virtual link and forwarding packets in a multi-hop wireless network.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an aspect of the present invention, there is provided a networking auto configuration method in a multi-hop wireless mesh network including a mesh router supporting an infrastructure mode and an Ad Hoc mode and wireless terminals capable of communicating with the mesh router using an infrastructure mode and forming a network using Ad Hoc mode, including the steps of: at a new wireless terminal connected to a new network, selecting one of Internet protocol (IP) addresses used in a mesh network and transmitting an IP auto setting message to neighbor wireless terminals; at a wireless terminal receiving the IP auto setting message, comparing an IP address in the IP auto setting message with an own IP address, and determining whether the IP address in the IP auto setting message is conflicted or not based on the comparison result; transmitting an IP conflict message to the new wireless terminal if the IP address in the IP auto setting message is conflicted with the own IP address; at a mesh router receiving the IP auto setting message, determining whether IP conflict occurs or not based on a wireless terminal mode information table, and transmitting an IP conflict message to the new wireless terminal through neighbor wireless terminals if the IP conflict occurs; at the new wireless terminal, repeatedly performing the selecting of the IP address if the new wireless terminal receives the IP conflict message; and at the new wireless terminal, setting the selected IP address as the own IP address if the new wireless terminal does not receive the IP conflict message for predetermined time.

In accordance with another aspect of the present invention, there is provided a virtual link setting method in a multi-hop wireless mesh network including a mesh router supporting an infrastructure mode and an Ad Hoc mode and wireless terminals capable of communicating with the mesh router using an infrastructure mode and forming a network using Ad Hoc mode, including the steps of: at a source terminal, generating a virtual link request message according to a virtual link setting request and transmitting the generated virtual link request message to adjacent nodes; at a node receiving the virtual link request message, determining whether an entry having a virtual link identifier identical to a virtual link identifier in the received virtual link request message is in a virtual link information table or not; removing the received virtual link request message if the identical entry is in the virtual link information table; adding a new entry into the virtual link information table and retransmitting the virtual link request message to adjacent nodes if the identical entry is not in the virtual link information table and if a destination is not oneself; generating a virtual link response message and transmitting the virtual link response message to adjacent nodes if the identical entry is not in the virtual link information table and if the destination is oneself; at a node receiving the virtual link response message, determining whether an entry having a virtual link identifier identical to that in the received virtual link response message is in the virtual link information table or not; comparing a quality of link (QoL) in the virtual link response message with a QoL of an entry stored in the virtual link information table if the identical entry is in the virtual link information table; removing the received virtual link response message if the QoL of the entry stored in the virtual link information able is better according to the comparison result; removing the entry of the virtual link information table if the QoL of the virtual link response message is better according to the comparison result, and adding an entry as information of the virtual link response message; adding a new entry in the virtual link information table if the identical entry is not in the virtual link information; retransmitting the virtual link response message to adjacent nodes if a destination IP address is different from an own IP address after the adding of the new entry; after the adding of the new entry, removing the virtual link response message if the destination IP address is identical to the own IP address and terminating virtual link setting.

In accordance with an aspect of the present invention, there is provided a packet transmitting method in a multi-hop wireless mesh network including a mesh router supporting an infrastructure mode and an Ad Hoc mode and wireless terminals capable of communicating with the mesh router using an infrastructure mode and forming a network using Ad Hoc mode, including the steps of: at a transmitting terminal, searching an entry having a value identical to an IP address of a destination terminal in a data packet from a destination IP field of the virtual link information table; transmitting a virtual link request message to the destination terminal if the entry is not searched, and setting a virtual link by receiving a virtual link response message from the destination terminal; composing a virtual link header by copying a virtual link identifier of an searched entry into a virtual link identifier field of a virtual link header of the data packet if the entry is searched, and transmitting a data packet to adjacent nodes; at an adjacent node receiving the data packet, confirming whether an entry identical to a virtual link identifier of the received data packet is in the virtual link information table if a destination IP address is difference from an IP address of the adjacent node; removing the received data packet if the identical entry is not in the virtual link information table; updating a TTL value and a hop in the virtual link header if the identical entry is in the virtual link information table, and transmitting the virtual link header to a next hop node; at an adjacent node receiving the data packet, generating a virtual link response message having a destination as the transmitting terminal that transmits the data packet to an adjacent node if a destination IP address is identical to an IP address of the adjacent node and if a quality of link (QoL) value of a virtual link header is smaller than a predetermined threshold value; and transferring a received data packet to a network layer after the generation of the virtual link response message.

In accordance with an aspect of the present invention, there is provided a wireless terminal capable of communicating with a mesh router supporting an infrastructure mode and an Ad Hoc mode using an infrastructure mode and of forming a network using an Ad Hoc mode, including: a layer 3 adaptation unit for transmitting and receiving an Internet protocol (IP) packet to/from a network layer; a routing message generation unit for generating a virtual request message if a virtual link setting request from the layer 3 adaptation unit, and generating the virtual link response message according to a request of transmitting the virtual link response message; a virtual link information storing unit for storing a virtual link information table; a layer 2 adaptation unit for transmitting and receiving the virtual link request message and the virtual link response message to/from a data link layer; a routing message processing unit for updating the virtual link information table by processing a virtual link request message received by the layer 2 adaptation unit, performing necessary operation to retransmit the virtual link request message to adjacent nodes if an destination IP address of the virtual link request message is not an own IP address, and requesting the routing message generation unit to generate the virtual link response message if an destination IP address of the virtual link request message is an own IP address; and a data relay unit for composing a virtual link header by confirming a virtual link identifier of a destination terminal through the virtual link information table if a data packet relay request is received through the layer 3 adaptation unit, transmitting the data packet through the layer 2 adaptation layer, performing a necessary operation to retransmit the received data packet to adjacent nodes if a destination IP address of a data packet received through the layer 2 adaptation unit is not an own IP address, and transferring a data packet to a network layer through the layer 3 adaptation unit if the destination IP address of the received data packet is an own IP address.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

### BRIEF DESCRIPTION OF THE DRAWINGS

FIG. 1 is a diagram illustrating a multi-hop wireless mesh network where the present invention is applied.

FIG. 2A is a flowchart for describing the operation of a wireless terminal in a multi-hop wireless mesh network in accordance with an embodiment of the present invention.

FIG. 2B is a diagram illustrating a structure of an active/passive mesh mode change message in accordance with an embodiment of the present invention.

FIG. 3A is a diagram for describing a mesh network auto configuration method between wireless terminals in accordance with an embodiment of the present invention.

FIG. 3B is a diagram illustrating a message for a mess network auto configuration in accordance with an embodiment of the present invention.

FIG. 3C is a diagram illustrating a mode information table of a wireless terminal managed in a mesh router.

FIGS. 4A and 4B are diagrams for illustrating a mode shift process in a wireless terminal in accordance with an embodiment of the present invention.

FIG. 5A is a diagram illustrating a network stack employed in a wireless terminal in accordance with an embodiment of the present invention.

FIG. 5B is a block diagram illustrating a wireless terminal for setting a virtual link and transmitting packets in accordance with an embodiment of the present invention.

FIG. 6A is a diagram illustrating a structure of a virtual link header for setting a routing path and forwarding packets in accordance with an embodiment of the present invention.

FIG. 6B is a diagram illustrating a virtual link information table in accordance with an embodiment of the present invention.

FIGS. 7A and 7B are a flowchart and a diagram for describing a virtual link request message processing procedure in a wireless terminal in accordance with an embodiment of the present invention.

FIGS. 8A and 8B are a flowchart and a diagram for describing a virtual link response message processing procedure in a wireless terminal in accordance with an embodiment of the present invention.

FIG. 9 is a flowchart illustrating a packet transmission method in a wireless terminal in accordance with an embodiment of the present invention.

### DESCRIPTION OF SPECIFIC EMBODIMENTS

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

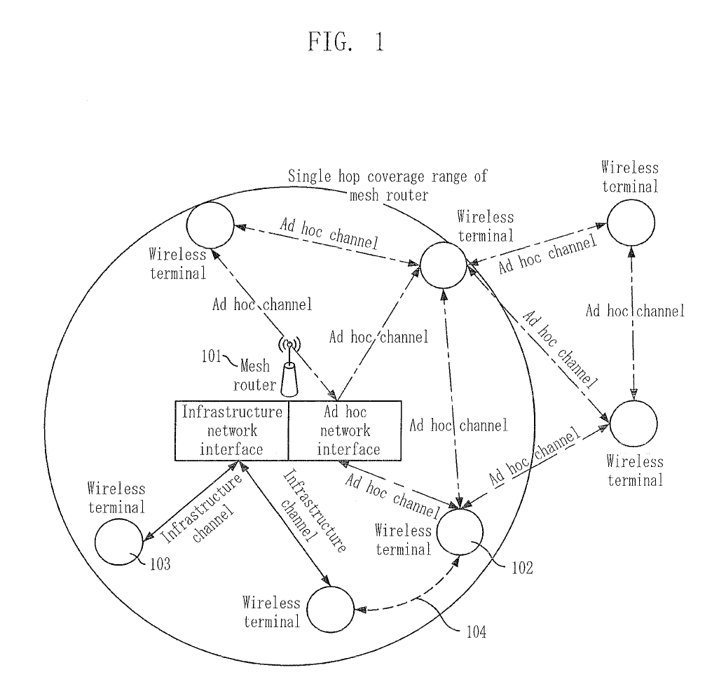

FIG. 1 is a diagram illustrating a multi-hop wireless mesh network where the present invention is applied.

The multi-hop wireless mesh network includes a mesh router 101 having interfaces for an infrastructure mode and an Ad-Hoc mode at the same time and wireless terminals having a single wireless interface. Wireless terminals 102 and 103 operate in one of an infrastructure more and an Ad Hoc mode.

The wireless terminal 102 operating in the Ad Hoc mode and the mesh router form a multi-hop based Ad Hoc network. A wireless terminal 103 operating in an infrastructure mode and a mesh router form an infrastructure network where the wireless terminal 103 communicates with the mesh router through a single hop communication scheme.

In order to guarantee the mobility and connectivity, the wireless terminal generally operates in the Ad Hoc mode. When a wireless terminal needs a high bandwidth, the wireless terminal can be provided with the same bandwidth of the typical infrastructure network by changing the Ad Hoc mode to the infrastructure mode. Therefore, the multi-hop wireless mesh network according to the present embodiment does not have the mobility and connectivity limitation problem unlike the typical infrastructure based single hop wireless LAN. In the present embodiment, different channels are assigned for an Ad Hoc network and an infrastructure network. Accordingly, competition for occupying a channel is reduced in the present embodiment. Therefore, the performance of a network improves.

The multi-hop wireless mesh network according to an embodiment of the present invention is a mesh network having an infrastructure network and an Ad Hoc network at the same time. The mesh network relays packets by connecting two networks, the infrastructure network and the Ad Hoc network. Also, a mesh router performs an access point function and a DHCP service function in order to sustain the compatibility with the typical infrastructure based single hop wireless network. A wireless terminal operating in a typical infrastructure mode does not have the comparability problem because a mesh router performs the function of an access point.

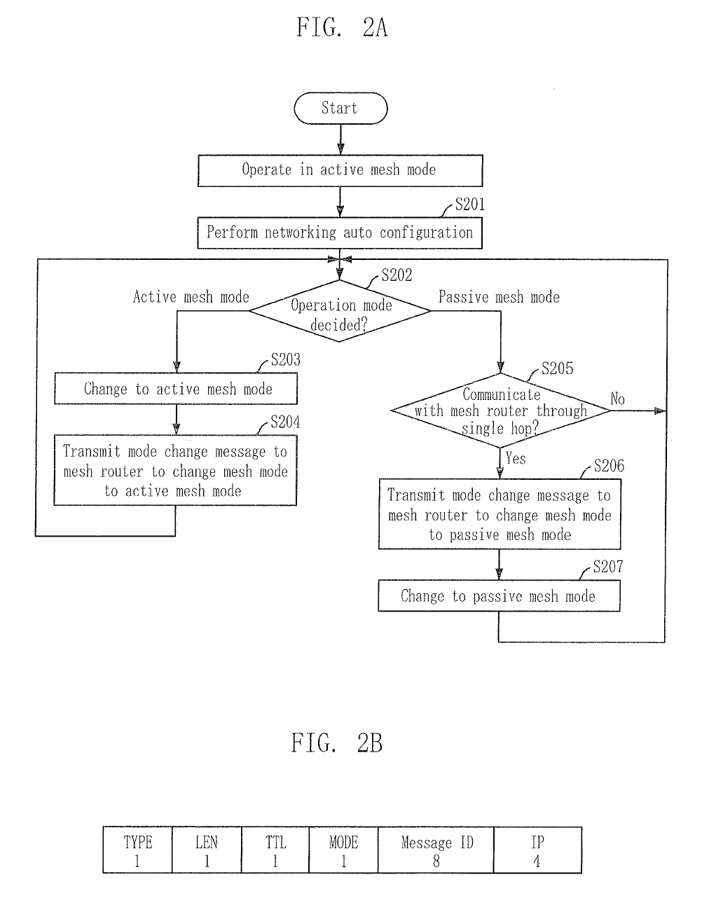

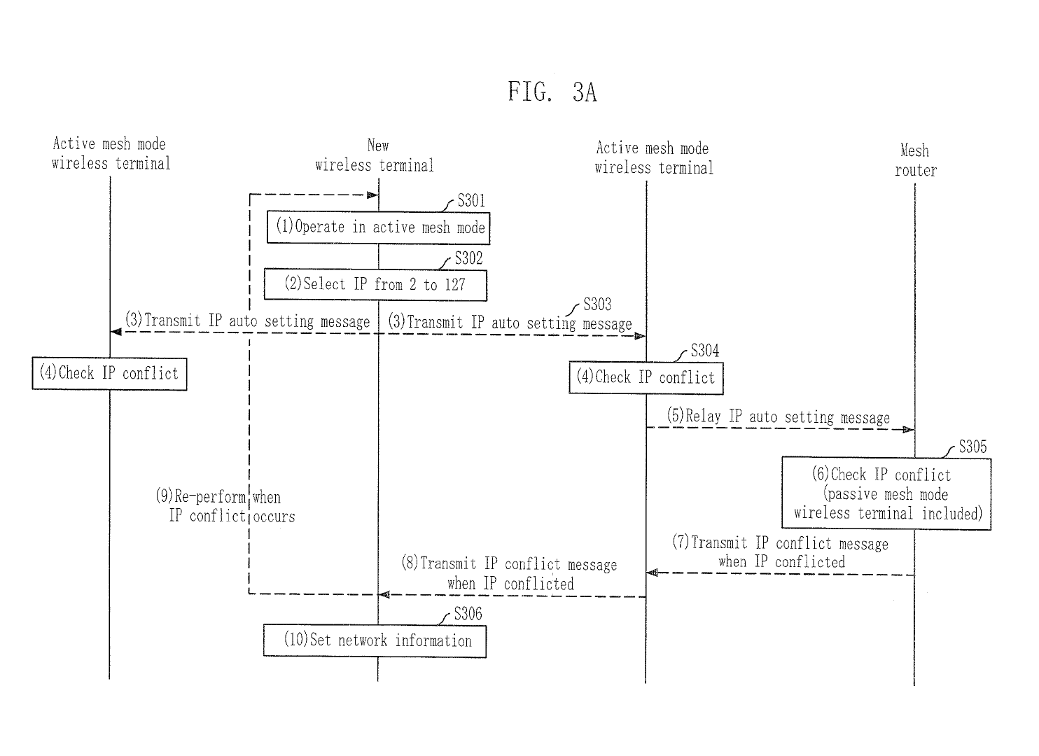

FIG. 2A is a flowchart for describing the operation of a wireless terminal in a multi-hop wireless mesh network in accordance with an embodiment of the present invention, and FIG. 2B is a diagram illustrating a structure of a mode shift message in accordance with an embodiment of the present invention.

In the present embodiment, the operation mode of a wireless terminal forming a mesh network is divided into an active mesh mode and a passive mesh mode. A wireless terminal operating in the active mesh node relays packets of the other wireless terminal in order to improve the connectivity of a network and uses an interface for an Ad Hoc mode. On the contrary, a wireless terminal operating in the passive mesh mode communicates with a mesh router with a single hop in order to receive a high bandwidth service and does not relay the packet of other wireless terminal. The wireless terminal operating in the passive mesh mode uses an interface for an infrastructure mode.

As shown in FIG. 2A, the wireless terminal forming a mesh network basically operates in an active mesh mode to guarantee the mobility and the connectivity. At step S201, the wireless terminal sets an IP address by performing a networking auto configuration procedure in order to participate in a mesh network. After performing the networking auto configuration procedure, the wireless terminal participates in the mesh network.

When a wireless terminal needs to change a mode, the wireless terminal decides an operation mode at step S202 and changes a current mode to the decided operation mode. Since a wireless terminal and a mesh router communicate with each other based on a single hop communication scheme in the passive mesh mode, it is determined whether a wireless terminal communicates with a mesh router using the single hop communication scheme or not at step S205. The wireless terminal does not change the active mesh mode to the passive mesh mode if the wireless terminal cannot communicate with the mesh router using the single hop communication scheme.

If the wireless terminal can communicate with the mesh router using the single hop communication scheme at step S205, the wireless terminal transmits a passive mesh mode change message to the mesh router to change the active mesh mode to the passive mesh mode at step S206. Then, the active mesh mode changes to the passive mesh mode by changing a wireless interface mode to an infrastructure mode at step S207. On the contrary, the passive mesh mode changes to an active mesh mode by changing a wireless interface mode to an Ad Hoc mode at step S203 and transmitting an active mesh mode change message to a mesh router to at step S204.

FIG. 2B is a diagram illustrating a structure of a mode change message in accordance with an embodiment of the present invention.

Referring to FIG. 2B, the mode change message includes an active mesh mode change message and a passive mesh mode change message. The mode change message includes 1-byte of a TYPE field, 1-byte of a LEN field, 1-bypte of a TTL field, 1-byte of a MODE field, 8-bytes of a message ID field, and 4-bytes of an IP field. The TYPE field has a value of ‘1’ for indicating a mode change message. The LEN has a value of ‘4’ for expressing a length of a mode change message in a four-byte unit. The TTL field expresses the number of hops to transmit a mode change message. The TTL field has an initial value of ‘16’ but it changes according to an environment of a wireless mesh network. The MODE field denotes a mode to change at a wireless terminal. The MODE field has a value of ‘0’ for the active mesh mode, and the mode field has a value of ‘1’ for the passive mesh mode. The message ID field is used to identify messages having the same type field values.

The upper most 2-bytes of the message ID field are randomly selected, and the lower most 6-bytes are identical to the MAC address of a terminal that generates a message. The IP field has the IP address of a terminal that changes a mode.

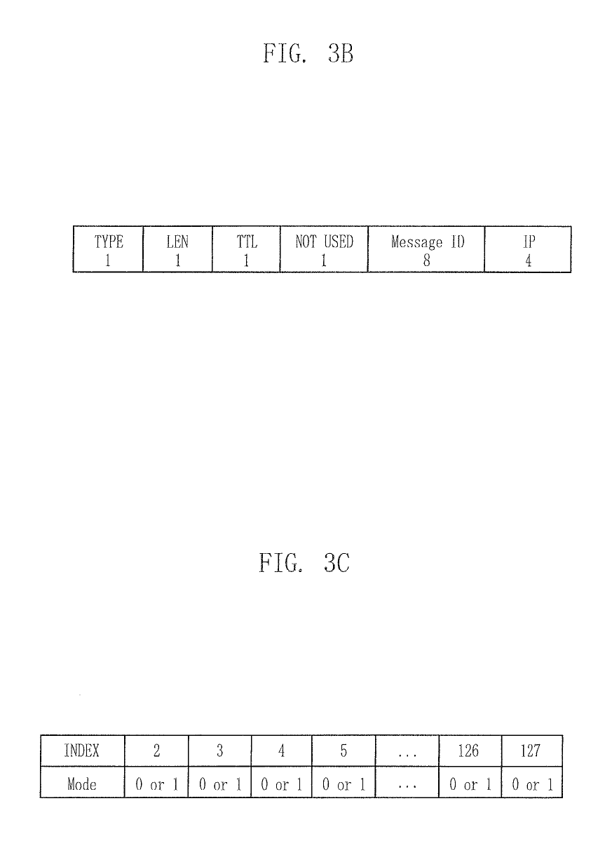

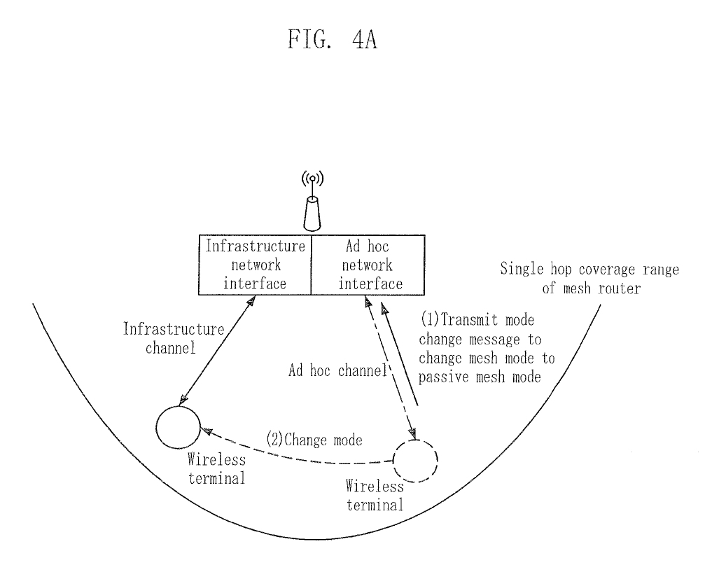

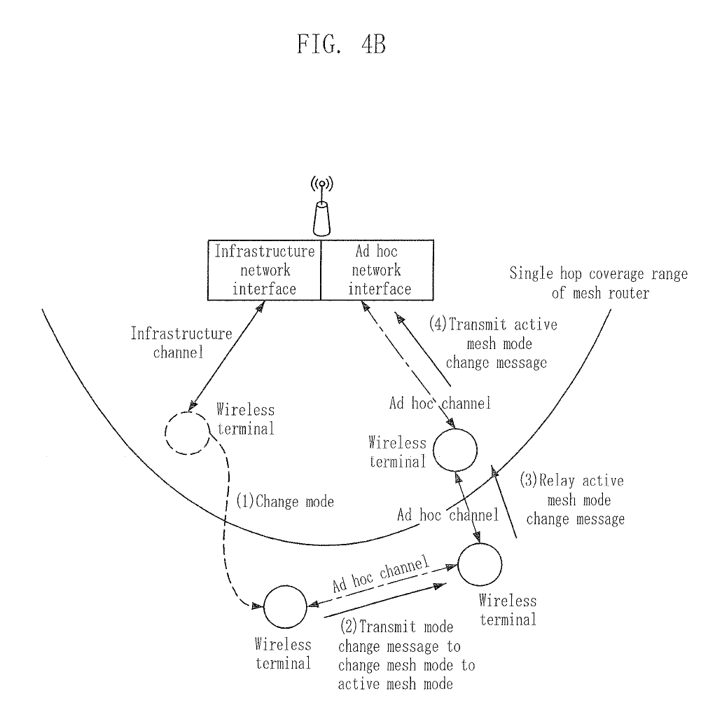

FIG. 3A is a diagram for describing a mesh network auto configuration method between wireless terminals in accordance with an embodiment of the present invention.

The mesh networking auto configuration method according to the present embodiment assigns an IP address without IP conflict with IP addresses assigned to other wireless terminals. The mesh networking auto configuration method according to the present embodiment also guarantee connectivity without changing the IP address of a wireless terminal although a physical network phase changes due to mode change.

The mesh network according to the present embodiment uses a C class of an IP address that starts with ‘192.168.17’. In order to prevent IP conflict between an IP address assigned through the mesh networking auto configuration method according to the present embodiment and an IP address used in a typical infrastructure based single hop wireless LAN, the entire IP address region is classified into two sub-classes. In the C class, total 256 IP addresses are available. A mesh router uses an IP address having a value of ‘1’ for the last 8 bits. Also, an IP address having a value of ‘254’ for the last 8 bits is used for broadcast. IP addresses having values ‘0’ and ‘254’ for the last 8 bits are reserved. Among remaining 252 IP addresses, IP addresses having values ‘2’ to ‘127’ for the last 8 bits are used in a mesh network, and IP addresses having values ‘128’ to ‘253’ for the last 8 bits are managed by a DHCP server.

Referring to FIG. 3A, a new wireless terminal elected one of IP addresses 192.168.17.2 to 192.168.17.127, which are used in a mesh network at step S302. Then, the wireless terminal generates an IP auto setting message and transmits the generated IP auto setting message to neighbor wireless terminals at step S303.

The IP auto setting message, as shown in FIG. 3b, includes 1-byte of a TYPE field, 1-byte of a LEN field, 1-byte of TTL field, 1-byte of a NOT USED field, 8-byte of message ID field, and 4-byte of IP field. The type field has a value of ‘2’ for indicating the IP auto setting message. The LEN field has a value of ‘4’ for indicating the length of the IP auto setting message in a 4-byte unit. The TTL field denotes the number of hops to transmit an IP auto setting message. The TTL field has an initial value of ‘16’ but it changes according to an environment of a wireless mesh network. The NOT USED field is a reserved field that is not currently used. The message ID field is used to identify messages having the same type field values. The upper most 2-bytes of the message ID field are randomly selected, and the lower most 6-bytes are identical to the MAC address of a terminal that generates a message. The IP field has the IP address of a terminal that performs networking auto configuration.

The neighbor terminal receiving the IP auto setting message transmits the received IP auto setting message to other neighbor terminals. By repeatedly performing such operations, the IP auto setting message is transmitted to all of wireless terminals.

At step S304, a wireless terminal receiving the IP auto setting message compares an IP field value of the received IP auto setting message with the own IP address. If the IP field value of the received IP auto setting message is identical to the own IP address, the wireless terminal generates an IP conflict message as shown in FIG. 3b and transmits the generated IP conflict message to neighbor wireless terminals.

The IP conflict message has the same structure of the IP auto setting message except that a TYPE field of the IP conflict message has a value of ‘3’ to be distinguished from other messages. The other fields of the IP conflict message are used identically to those of the IP auto setting message.

At step S305, the mesh router determines whether the IP field value of the IP auto setting message is conflicted with an IP address of the mesh router or not or determines whether the IP field value of the IP auto setting message is conflicted with an IP address of a wireless terminal operating in a passive mesh mode.

If a wireless terminal uses an IP address identical to the IP field value of the IP auto setting message, the mesh router generates an IP conflict message and transmits the generated IP conflict message to neighbor wireless terminals. The mesh router sustains 126-bit of a wireless terminal mode information table as shown in FIG. 3.

As shown in FIG. 3C, the wireless terminal mode information table includes 126 indexes from 2 to 127. Each of the indexes has ‘0’ or ‘1’ as a mode value. If an index has ‘0’ as the mode value, it means that a wireless terminal having a corresponding index value as the last 8-bits of the IP address operates in an active mode. If an index has ‘1’ as the mode value, it means that a wireless terminal having a corresponding index value as the last 8-bits of the IP address operates in a passive mode.

As described above with reference to FIG. 2A, the wireless terminal transmits a mode change message to a mesh router whenever the wireless changes a mode. Therefore, a mesh router updates the wireless terminal mode information table of FIG. 3C whenever the mesh router receives the mode change message.

A wireless terminal performing networking auto configuration transmits an IP auto setting message and waits for a predetermined time in order to set an IP address. If the wireless terminal does not receive an IP conflict message while waiting, the wireless terminal sets an IP address selected for networking auto configuration as an own IP address. If the wireless terminal receives an IP conflict message while waiting, the wireless terminal selects an IP address and transmits an IP auto setting message again. Preferably, a time for waiting the IP conflict message may be initially set as about 3 seconds. However, it may change according to a network environment.

After a wireless terminal is allocated an IP address through the aforementioned procedure, the wireless terminal can use the same IP address although the wireless terminal changes an operation mode because it is not necessary to perform networking auto configuration again. In order to support the wireless terminal to use the same IP address, the mesh router relays packets based on the wireless terminal mode information table. When a wireless terminal operating in an active mesh mode communicates with a wireless terminal operating in a passive mesh mode, the mesh route operates as a relay node.

Also, a mesh router can select a wireless interface to relay a packet from an external Internet based on a wireless terminal mode information table. Therefore, the IP mobility is guaranteed in a mesh network without requiring additional communication scheme such as mobile IP.

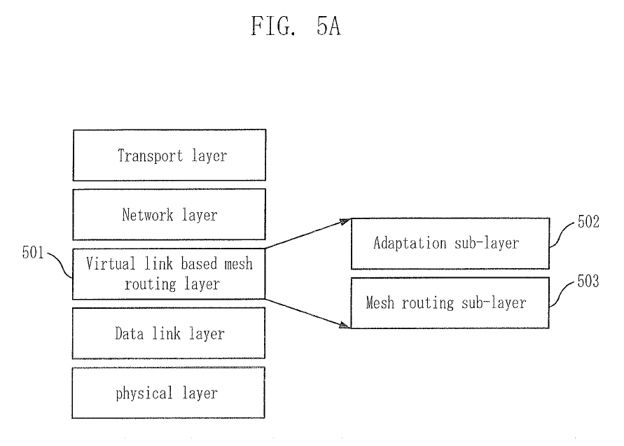

Hereinafter, a mode change procedure will be described with reference to FIGS. 4A and 4B.

Each of wireless terminals selects an operation mode based on a request of a user, a quality of an application service, and quality of service (QoS) in a wireless link.

In order to change an active mesh mode to a passive mesh mode, a wireless terminal performing a mode change operation transmits a passive mesh mode change message directly to a mesh router to change an operation mode to a passive mess mode as shown in FIG. 4A. Then, the wireless terminal performs the mode change operation.

When a single hop communication is interrupted between a wireless terminal and a mesh router because the wireless terminal moves, the wireless terminal needs to change the passive mesh mode to the active mesh mode. Therefore, the mode change operation from the passive mesh mode to the active mesh mode is considered when a wireless terminal has difficulty to directly communicate with a mesh router through a single hop communication scheme. Therefore, the wireless terminal needs to perform the mode change operation first. Then, the wireless terminal transmits an active mesh mode change message from the passive mesh mode to the active mesh mode to the mesh router through multi-hop.

When the mesh router receives the passive mesh mode change messages to change the active mesh mode to the passive mesh mode and vice versa, the mesh router updates the wireless terminal mode information table as shown in FIG. 3C.

Hereinafter, a mesh routing protocol employed in a wireless terminal will be described in detail.

The mesh routing protocol according to the present embodiment denotes a virtual link based mesh routing (VLMR) scheme.

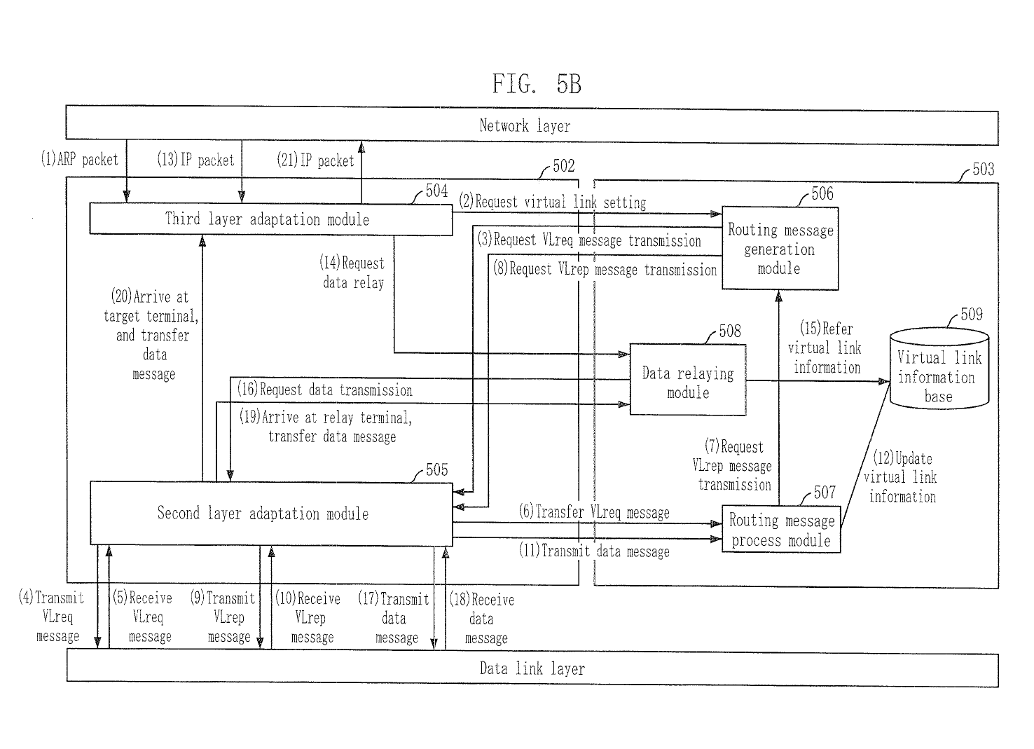

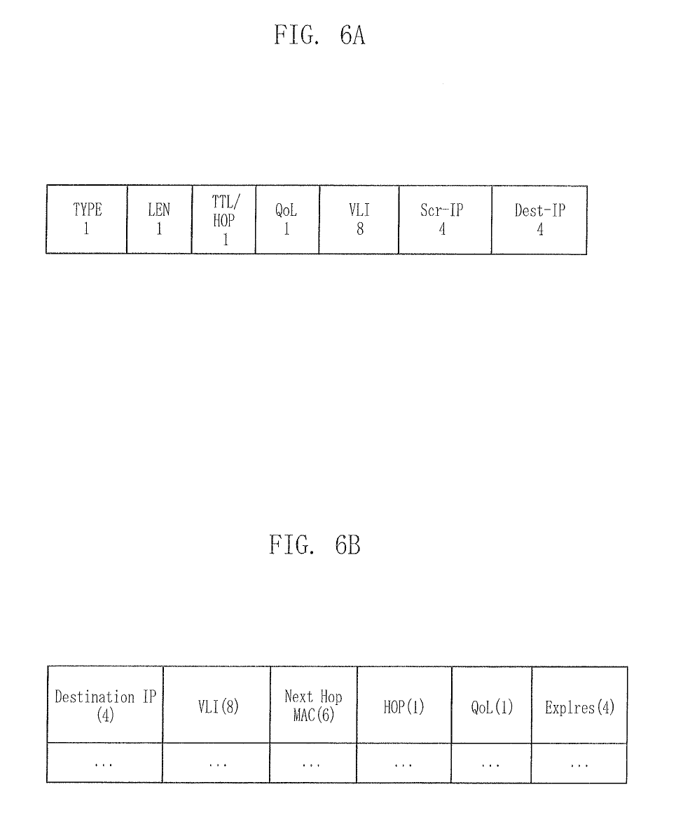

The VLMR protocol, as shown in FIG. 5A, is embodied as a virtual link based mesh routing (VLMR) layer 501 between a network layer and a data link layer. The VLMR layer 501 includes an adaptation sub-layer 502 and a mesh routing sub-layer 503. The shown network protocol stack is a routing scheme performed in a lower layer than the network layer, which does not refer to the contents in an IP header. In a view of the network layer, a source terminal communicates with a target terminal through virtual single hop, logically. Therefore, a routing path generated according to the present embodiment is referred as a virtual link.

The adaptation sub-layer 502 operations as an interface between the virtual link based mesh routing (VLMR) layer 501 and a upper/lower layer, for example, the network layer and the data link layer. The adaptation sub-layer 502 is dependable to an operating system. The adaptation sub-layer 520 also sustains compatibility with an existing system and can be transplanted to various systems. For this, the adaptation sub-layer 502 includes a layer 3 adaptation module 504 operating as an interface to an upper layer such as an IP layer, and a layer 2 adaptation module 505 operating as an interface to a lower layer such as a data link layer.

The layer 3 adaptation module 504 receives a packet from a network layer and transfers the received packet to the mesh routing sub-layer 503. The layer 3 adaptation module 504 also transfers the packet received through mesh routing to the network layer again. The layer 2 adaptation module 505 receives a message from the mesh routing sub-layer 503, transmits the received message through a physical wireless interface, and transfers the received message to the routing sub-layer 503 again.

In order to multi-hop based mesh routing, the mesh routing sub-layer 503 generates and processes a virtual link request message (VLreq) and a virtual link reply (VLrep) message, and forwards data. The mesh routing sub-layer 503 is independent from the operating system. In order to perform such functions, the mesh routing sub-layer 503 includes a routing message generation module 506, a routing message processing module 507, and a data relay module 508, and include a virtual link information table 509 for storing the generated virtual link information.

Hereinafter, function blocks of a wireless terminal according to an embodiment of the present invention will be described with reference to FIG. 5B.

Referring to FIG. 5B, a wireless terminal according to the present embodiment includes a layer 3 adaptation module 504, a routing message generation module 506, a virtual link information base 509, a layer 2 adaptation module 505, a routing message processing module 507, and a data relay module. The layer 3 adaptation module 504 transmits and receives an IP packet to/from a network layer. The routing message generation module 506 generates a virtual link request message when a request for setting a virtual link is received from the layer 3 adaptation module 504, and generates a virtual link response message according to a request of transmitting the virtual link response message. The virtual link information base 509 stores a virtual link information table. The layer 2 adaptation module 505 transmits and receives the virtual link request message and the virtual link response message to/from a data link layer. The routing message processing module 507 processes a received virtual link request message from the layer 2 adaptation module 505 and updates the virtual link information table based on the processing result. The routing message processing module 507 also performs necessary operations to retransmit the virtual link request message to an adjacent node if the destination IP address of the virtual link request message is not the IP address of oneself. If the destination IP address is the IP address of oneself, the routing message processing module requests the routing message generation module 506 to generate the virtual link response message. The data relay module receives a data packet relay request through the layer 3 adaptation module, confirms a virtual link identifier of a destination terminal through the virtual link information table, composes a virtual link header, and transmits the data packet through the layer 2 adaptation module. If the target IP address of the data packet received through the layer 2 adaptation module is not the IP address of oneself, the data relay module performs necessary operations to retransmit the received data packet to the adjacent node. If the destination IP address of the received data packet is not the IP address of oneself, the data relay module transfers the data packet to the network layer through the layer 3 adaptation module.

Hereinafter, the protocol stack of the wireless terminal having the aforementioned constitute elements will be described with reference to FIG. 5B.

In the present embodiment, a procedure of setting a virtual link is dynamically performed. In order to set a virtual link in the virtual link based mesh routing protocol, it is necessary to perform a virtual link request procedure and a virtual link establishing procedure. In the virtual link request procedure, a source wireless terminal trying to communicate transmits a virtual link request (VLreq) message to a destination wireless terminal. In the virtual link establishing procedure, the destination wireless terminal receiving the virtual link request (VLreq) message generates a virtual link request (VLreq) message and transmits the virtual link request message to the source wireless terminal.

In wireless LAN based communication, an address resolution protocol (ARP) packet is generated before data is transmitted. The virtual link based mesh routing (VLMR) layer starts a virtual link request procedure when the ARP packet is generated. The routing message generation module 506 of the mesh routing sub-layer generates a virtual link request message (VLreq) and transmits the generated VLreq message through the layer 2 adaptation module 505.

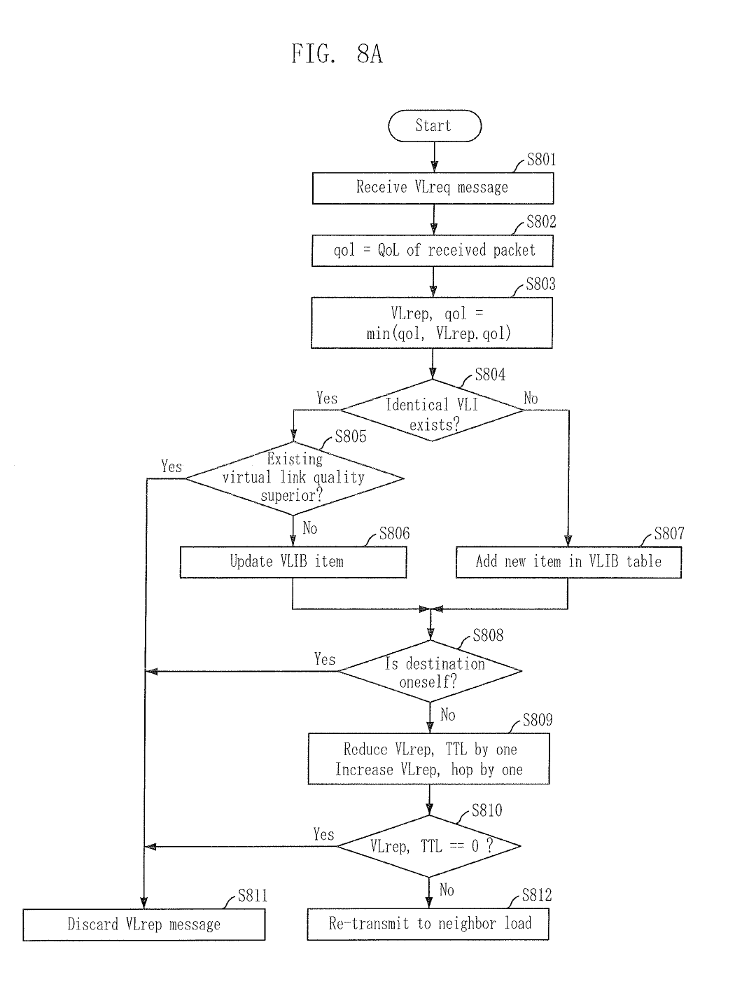

In a mesh network, each wireless terminal or a mesh router relays a virtual link message to a destination wireless terminal through broadcasting. Hereinafter, a procedure for processing a virtual link request message (VLreq) in the routing message processing module 507 will be described with reference FIG. 7A in later.

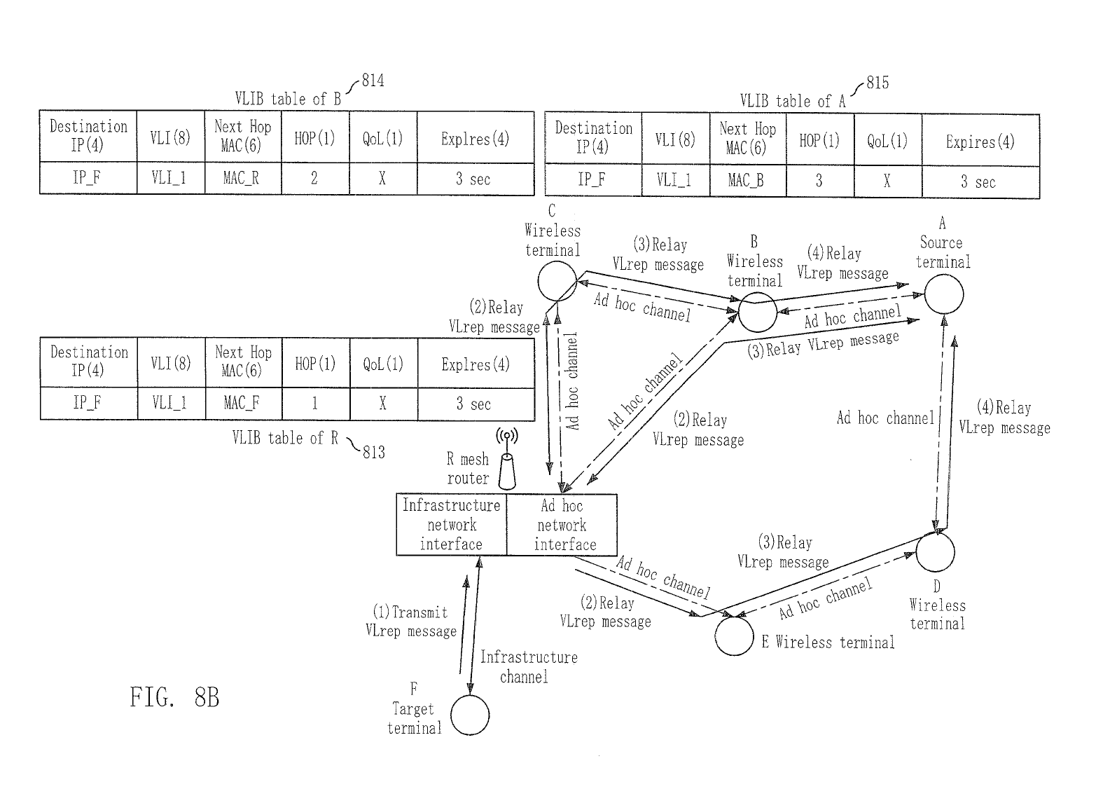

The routing message processing module 507 of a destination wireless terminal receiving a virtual link request (VLreq) message requests the routing message generation module 506 to generate a virtual link response (VLrep) message. The routing message generation module 506 generates a virtual link response (VLrep) message and transmits the generated virtual link response message to a mesh network through the layer 2 adaptation module. In the mesh network, each wireless terminal or a mesh router relays the virtual link response (VLrep) message to a source wireless terminal through broadcasting. A procedure for processing a virtual link response (VLrep) message in the routing message processing module 507 of each wireless terminal will be described with reference to FIG. 8A.

A source wireless terminal receiving a virtual link response (VLrep) message stores virtual link information generated in a virtual link information table.

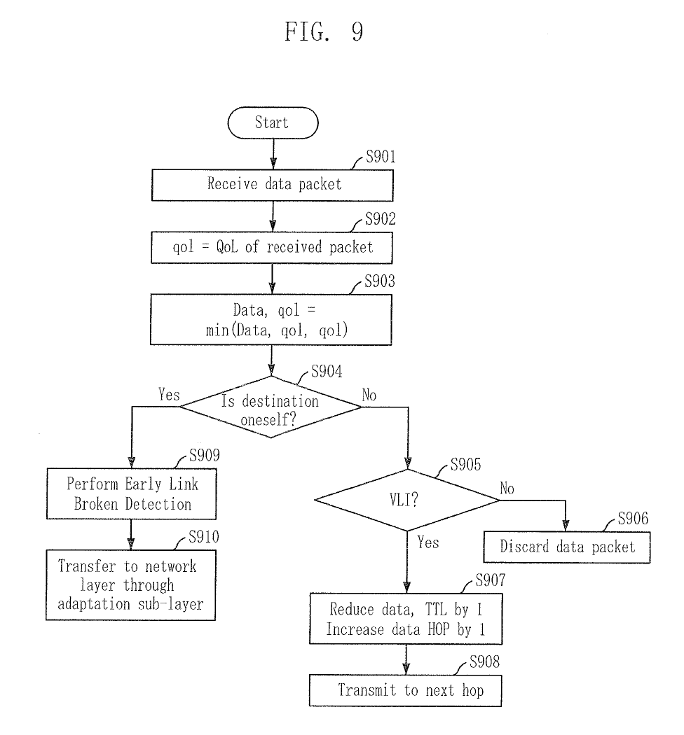

After a virtual link is set, an IP packet is transferred to the data relay module 508 through the layer 3 adaptation module 504. The data relay module 508 relays the IP packets to a destination based on the information in the virtual link information table 509. The IP packet arrived at the destination terminal is transferred to the network layer through the layer 3 adaptation module. The operations of the data relay module 508 will be described with reference FIG. 9 in later.

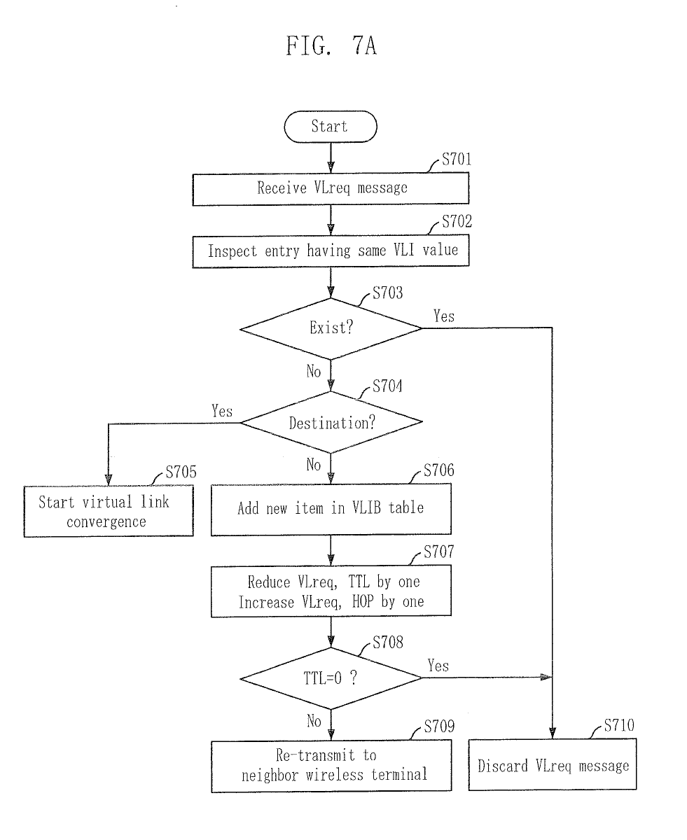

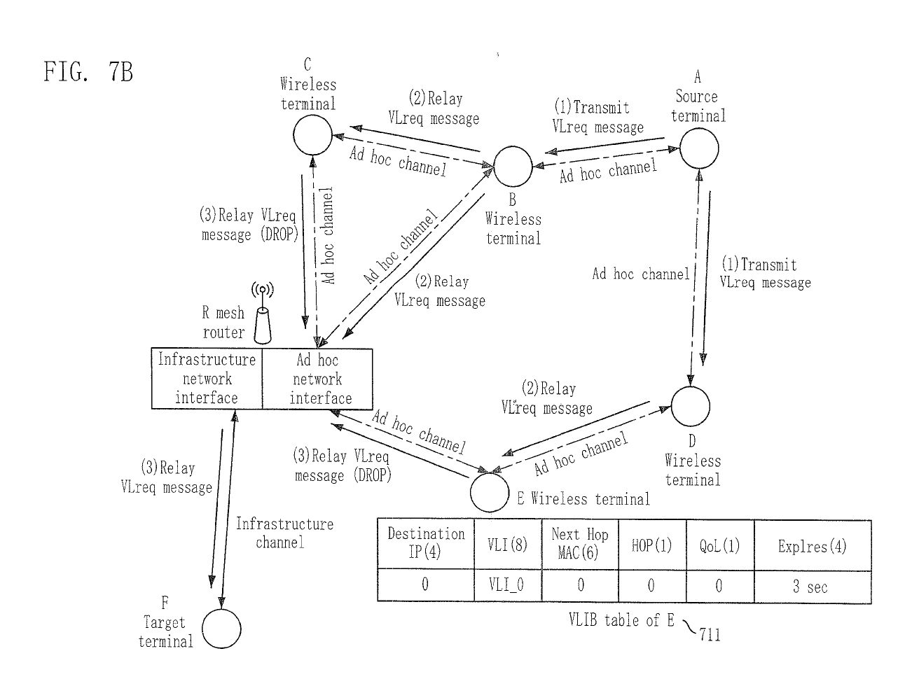

FIG. 6A is a diagram illustrating a structure of a virtual link header for setting a routing path and forwarding packets in accordance with an embodiment of the present invention, and FIG. 6B is a diagram illustrating a virtual link information table in accordance with an embodiment of the present invention.

As shown in FIG. 6A, the virtual link routing protocol header includes 1-byte of TYPE field, 1-byte of LEN field, 1-byte of TTL/HOP field, 1-byte of QoL field, 8-byte of VLI field, 4-byte of Scr-IP field, and 4-byte of Dest-IP field. The TYPE field has a unique value to identify the type of a message. For example, the TYPE field has a value of ‘4’ for a virtual link request (VLreq) message, a value of ‘5’ for a virtual link response (VLrep) message, and a value of ‘6’ for a data message. The LEN field has a value of ‘6’ for expressing the length of a message in a 4-byte unit. The TTL/HOP field uses 4-bits each to indicate the number of hops to transmit a message and the number of hops that a message passes through. The QoL field has a value expressing a Quality of a link that relays a message, which is the minimum QoL among links in a path formed of multiple hops. The QoL field has a value regulated based on 255. The initial value of the QoL field is 255. The VLI field expresses a virtual link identifier. The upper most 2-bytes of the VLI field are randomly selected, and the lower most 6-bytes is an MAC address of a terminal generating a message. The Scr-IP field has an IP address of a terminal generating a message, and the Dest-IP field has an IP address of a destination terminal.

FIG. 6B is a diagram illustrating a virtual link information table in accordance with an embodiment of the present invention.

As shown in FIG. 6B, the virtual link information table includes 4-byte of a Destination IP field, 8-byte of a VLI field, 6-byte of Next Hop MAC field, 1-byte of HOP field, 1-byte of QoL field, and 4-byte of Expires field. The Destination-IP field is an IP address of a destination terminal in a virtual link. The VLI field is a virtual link identifier. All of terminals forming a virtual link have a VLIB entry having the same VLI. The Next Hop MAC field is an MAC address of a wireless terminal corresponding to a next hop in a virtual link. The HOP field denotes the number of hops remaining to arrive a final destination terminal which is indicated by the Destination-IP field. The QoL field denotes the QoL of a generated routing path, and the Expires field denotes a valid time of a routing path.

A wireless terminal having data to transmit generates a virtual link request message and transmits the generated virtual link request message to adjacent nodes, for example, wireless terminals and a mesh router, through broadcasting. The Scr-IP field of the virtual link request message is assigned as an IP address of a source terminal, and the Destination-IP field is assigned as an IP address of a destination terminal. The virtual link identifier (VLI) is generated by a source terminal.

FIG. 7A is a flowchart of a virtual link request message processing procedure in a wireless terminal in accordance with an embodiment of the present invention.

Since the virtual link request (VLreq) message is broadcasted, it is possible to repeatedly transmit the same VLreq message through different wireless terminals. The repeatedly transmitted messages may cause unnecessary traffic, thereby deteriorating the network performance. In order to overcome such a problem, each wireless terminal stores the virtual link identifier information of a received link request message in a virtual link information base (VLIB) table. Since the repeatedly transmitted virtual link request messages have the same virtual link identifier (VLI) value, wireless terminals discard virtual link request messages having a virtual link identifier identical to entries stored in the virtual link information base (VLIB) table without processing. That is, a wireless terminal receiving a virtual link request message determines whether a virtual link identifier included in the received virtual link request message is stored in the VLIB table or not at step S702. If the same virtual link identifier is stored in the VLIB table at step S703, the wireless terminal discards the received virtual link request message at step S710.

Then, the wireless terminal inspects a destination IP address in the received virtual link request message. If the destination IP address is identical to the own IP address at step S704, that is, if the destination is the wireless terminal receiving the virtual link request message, the wireless terminal performs necessary operation for establishing a virtual link at step S705. If the destination IP address is not the own IP address, the wireless terminal stores the virtual link identifier (VLI) value of a new virtual link request message to the VLIB table. Herein, in the newly added VLIB entry, all fields are set to ‘0’ except the VLI field and the Expires field. The Expires field is set with a default value (Default_Expire_time). The expiration default value is about 3 seconds. Therefore, the entry is automatically removed after the expiration default value passes.

Then, a wireless terminal reduces a TTL field value of a virtual link protocol header by 1 to transfer a received virtual link request message to neighbor wireless terminals, and increase the HOP field value by 1 at step S707. If the TTL field value is 0 at step S708, the wireless terminal discards the virtual link request message because it is not necessary to relay the virtual link request message. If the TTL field value is not 0 at step S708, the wireless terminal retransmits the virtual link request message to adjacent wireless terminal at step S709.

FIG. 7B is a diagram illustrating the flow of a virtual link request (VLreq) message transmitted from a source terminal A to a destination terminal F.

A source terminal A transmits a virtual link request (VLreq) message to wireless terminals B and D. The wireless terminal B transmits the received VLreq message to a wireless terminal C and a mesh router R again. The wireless terminal D transmits the VLreq message to a wireless terminal E again.

Like the VLIB table 711 of the wireless terminal E, a wireless terminal receiving the virtual link request (VLreq) message generates a virtual link identifier base (VLIB) entry using a VLI field of the VLreq message and removes a repeated VLreq message having the same virtual link identifier (VLI) value.

In FIG. 7B, a virtual link request (VLreq) message can be transferred through three paths A->B->C->R->F, A->B->R->

F, and A->D->E->R->F. However, a mesh router R only transmits the first VLreq message, which is arrived at the mesh router R at first, to the wireless terminal F and discards the other VLreq messages.

A destination terminal receiving a VLreq message generates a virtual link response (VLrep) message and transmits the generated VLrep message to neighbor wireless terminals or a mesh router through broadcasting. Each field of the generated VLrep message is set as follows.

The QoL field is assigned with an initial value of 255. The Scr-IP field is assigned with an IP address of a destination terminal generating a virtual link response (VLrep) message. The Destination-IP field is assigned with an IP address of a source terminal that transmits a virtual link request (VLreq) message. The virtual link identifier (VLI) value is generated by a destination terminal.

FIG. 8A is a flowchart showing a procedure of processing a virtual link response message at a wireless terminal according to an embodiment of the present invention. The procedure of processing a virtual link response message at a wireless terminal will be described with reference to FIG. 8A.

When a wireless terminal receives a virtual link response message from a neighbor wireless terminal or a mesh router at step S801, the wireless terminal performs following operations to update the QoL field value of the virtual link response (VLrep) message.

The wireless terminal compares a QoL value of a link at the time of receiving the VLreq message with a QoL field of the VLrep message and stores the smaller QoL value in the QoL field value of a VLrep message at steps S802 and S803. Therefore, the QoL filed value of the V, as shown in FIG. 3, VLrep message is the minimum QoL that can be provided by the path.

Then, the wireless terminal determines whether the own VLIB table includes an entry having the same value of the VLI field of the VLrep message or not at step S804. Herein, the wireless terminal does not remove the overlapped VLrep message unlike the VLreq message. It is because the wireless terminal wants to select the highest quality of virtual link among various paths. Therefore, if the own VLIB table includes an entry having the same value of the VLI field of the VLrep message, the wireless terminal compares the qualities of virtual links based on the QoL field at step S805. If the number of hops to a destination terminal is small and the QoL value is larger, it is determined that the quality of the corresponding virtual link is good. It can be expressed as Eq. 1.

$$Quality of virtual link = \frac{{QoL}^{α}}{Hop} \qquad Eq . 1$$

In Eq. 1, a variable a is a positive integer larger than 1 and used to assign a weight to a QoL value. The initial value of the variable α is 2.

If the quality of the existing virtual link is better, the virtual link response message is discarded at step S11. On the contrary, if the quality of a new virtual link is better, an existing VLIB entry is removed, a new VLIB entry is generated, and the generated VLIB entry is stored in the VLIB table at step S806. If the own VLIB table does not include an entry having the same value of the VLI field of the VLrep message, the wireless terminal generates a new VLIB entry at step S807. At the step S807, the Destination IP field, the VLI field, the Next Hop MAC field, the HOP field, and the QoL field of the VLIB entry are assigned with a Src-IP field and a VLI field of a virtual link response (VLrep) message, an MAC address of a transmitter, a HOP value, and a QoL field value of an Ethernet header.

After updating the VLIB table, the wireless terminal compares an own IP address with a destination IP address of the VLrep message to determine whether the VLrep message is arrived at a destination terminal or not at step S808.

If the wireless terminal determines that the VLrep message is arrived at the destination terminal, the wireless terminal discards the VLrep message because it is not necessary to relay the VLrep message anymore. On the contrary, if the wireless terminal determines that the VLrep message is not arrived at the destination terminal, the wireless terminal reduces the TTL field of the VLrep message by 1 and increases the HOP field by 1 in order to retransmit the VLrep message to neighbor wireless terminals or mesh routers at step S809. Then, the wireless terminal checks a TTL field value at step S810. Only if the TTL field value is not 0, the wireless terminal retransmits the VLrep message to the neighbor wireless terminals or a mesh router at step S812.

Terminals in the path from a source terminal and a destination terminal have a VLIB entry having the same value of the VLI value set by the destination terminal that generates the VLrep message. Since the VLIB entry stores the next hop information, data forwarding is performed based on the VLI value. Such a data forwarding path is referred as a virtual link.

FIG. 8B is a diagram for describing the flow of a virtual link response (VLrep) message transmitted from a destination terminal F to a source terminal A in accordance with an embodiment of the present invention.

A mesh router R receiving a VLrep message from a target terminal F updates a VLIB table at step S813. In the VLIB table of the mesh router R, IP_F denotes an IP address of a terminal F, MAC_F denotes an MAC address of a terminal F, and VLI_1 is a value generated by a terminal F. Therefore, the mesh router R can learn that the MAC address of a next hop is MAC_F if the VLI field value of a data packet is VLI_1. Also, the mesh router R may learn that data can be transmitted to a terminal F through one hop because the HOP field has a value of 1.

Like a VLIB table 814 of a wireless terminal B receiving a VLrep message from a wireless terminal F, the wireless terminal B can communicate with the wireless terminal F through two hops and can learn that the next hop is the mesh router R.

Like a VLIB table 815 of a wireless terminal A receiving a VLrep message from a wireless terminal B, the terminal A can learn that data can be transmitted to the terminal F through three hops and the next hop is the terminal B.

When the terminal A transmits data to the terminal F, the VLI field of a virtual link header is assigned with VLI_1, and transmitted to the terminal B. The terminal B transmits the data to the mesh router R with reference to the VLIB table. Then, the mesh router R transmits data to the terminal F with reference to the VLIB table so that the terminal A communicates with the terminal F, finally.

In order to transmit data packet received from a network layer, a wireless terminal generates a data message having a virtual link header shown in FIG. 6 in the front of the IP header. The wireless terminal selects an entry where an IP address of a destination terminal of a data packet is identical to a Destination-IP field of a VLIB table. If no same entry is present, the wireless terminal performs the virtual link request procedure shown in FIG. 7A. The virtual link identifier (VLI) of the selected VLIB entry is duplicated to a VLI field of a virtual link header, and other fields are set with initial values. Then, the data packet is transmitted to a next hop based on the Next Hop field of the selected VLIB entry.

FIG. 9 is a flowchart illustrating a packet transmission method in a wireless terminal in accordance with an embodiment of the present invention.

Referring to FIG. 9, when a wireless terminal receives a data packet at step S901, the wireless terminal measures a QoL value and updates a QoL field value of a data packet only if the measure QoL value is smaller than the QoL field value of the data packet at steps S902 and S903. If the data packet is not arrived at a destination terminal, it is necessary to relay the data packet to the destination terminal. Therefore, the wireless terminal compares a Dest-IP field of a data packet with an own IP address at step S904 to determine whether the data packet is arrived at the destination terminal or not. If the wireless terminal is not the destination terminal, the wireless terminal determines whether a VLIB table includes an entry having a VLI value identical to the VLI value of the data packet or not at step S905. If the same VLI entry is not in the VLIB table, the wireless terminal discards the data packet at step S906. If the same VLI entry is in the VLIB table, a HOP field value and a TTL field value are updated at step S907. Based on the Next Hop field of a corresponding entry, the wireless terminal transmits the data packet to a wireless terminal of the next hop or a mesh router at step S908.

When the packet is arrived at the destination terminal, the wireless terminal performs an early link broken detection procedure at step S909. The purpose of the early link broken detection procedure is to prevent routing failure due to the movement of a wireless terminal. In order to achieve the purpose, the wireless terminal compares a QoL field value of a virtual link header with a predetermined threshold (ELBthreshold) when the wireless terminal receives the data message. If the QoL field value is smaller than the threshold value, the wireless terminal generates a VLrep message having a destination as a terminal transmitting the data and transmits the VLrep message to neighbor wireless terminals or a mesh router. All of terminals receiving the VLrep message perform a virtual link setting procedure. As a result, a routing path is updated between a source terminal to a destination terminal. Therefore, a new path can be secured before routing failure occurs. The threshold value (ELBDthreshold) is set according to a network and an environment whether a mesh routing scheme is applied. After the early link broken detection procedure ends, the data is transferred to a network layer through an adaptation sub-layer at step S910.

While the present invention has been described with respect to certain preferred embodiments, it will be apparent to those skilled in the art that various changes and modifications may be made without departing from the spirits and scope of the invention as defined in the following claims.

As described above, a mesh networking auto configuration method, a virtual link setting method, and a packet transmission method in a multi-hop wireless local area network (LAN), and a terminal thereof according to an embodiment of the present invention provide following effects.

At first, the mobility and connectivity limitation problem of a conventional infrastructure based single hop LAN can be overcome through a mesh network interacting with an Ad Hoc network and an infrastructure network.

Secondly, the performance limitation problem of the conventional Ad Hoc network can be solved.

Moreover, it is not necessary to perform a network reconfiguration procedure, which was conventionally required by a mode change operation, while sustaining mutual operation compatibility with the conventional single hop based infrastructure network.

Furthermore, since the present embodiment operates between a network layer and a data link layer, it is possible to provide IP mobility and connectivity to the upper layer, transparently. Therefore, a seamless service can be provided without requiring supplementary scheme such as a mobile IP.

Therefore, the mobility and connectivity of a wireless terminal is guaranteed in a multi-hop wireless LAN, and a seamless service can be provided. Also, a wireless terminal can be enabled to operate in a home gateway in a home networking field according to the present invention.

While the present invention has been described with respect to the specific embodiments, it will be apparent to those skilled in the art that various changes and modifications may be made without departing from the spirit and scope of the invention as defined in the following claims.

What is claimed is:

1. A networking auto configuration method in a multi-hop wireless mesh network including a mesh router supporting an infrastructure mode and an Ad Hoc mode and wireless terminals capable of communicating with the mesh router using an infrastructure mode and forming a network using Ad Hoc mode, comprising the steps of:
at a new wireless terminal connected to a new network, selecting one of Internet protocol (IP) addresses used in a mesh network and transmitting an IP auto setting message to neighbor wireless terminals;
at a wireless terminal receiving the IP auto setting message, comparing an IP address in the IP auto setting message with an own IP address, and determining whether the IP address in the IP auto setting message is conflicted or not based on the comparison result;
transmitting an IP conflict message to the new wireless terminal if the IP address in the IP auto setting message is conflicted with the own IP address;
at a mesh router receiving the IP auto setting message, determining whether IP conflict occurs or not based on a wireless terminal mode information table, and transmitting an IP conflict message to the new wireless terminal through neighbor wireless terminals if the IP conflict occurs;
at the new wireless terminal, repeatedly performing the selecting of the IP address if the new wireless terminal receives the IP conflict message; and
at the new wireless terminal, setting the selected IP address as the own IP address if the new wireless terminal does not receive the IP conflict message for predetermined time.

2. The networking auto configuration method of claim 1, further comprising the steps of:
at the wireless terminal, changing an operation mode to an active mesh mode if the wireless terminal wants to change an operation mode to the active mesh mode of an Ad Hoc scheme; and
transmitting an active mesh mode change message to the mesh router after the changing of the operation mode.

3. The networking auto configuration method of claim 2, further comprising the steps of:
at the wireless terminal, determining whether it is possible to communicate with the mesh router or not when the wireless terminal wants to change an operation mode to a passive mesh mode of an infrastructure scheme; and
informing that it is impossible to change the operation mode to the passive mesh mode if it is impossible to communicate with the mesh router; and
transmitting a passive mesh mode change message to the mesh router if it is possible to communicate with the mesh router and changes the operation mode to the passive mesh mode.

4. The networking auto configuration method of claim 1, wherein the IP auto setting message includes a type field for identifying a type of a message, a length field for indicating a length of a message, a TTL field for expressing the number of hops to transmit a message, a message identification field for identifying a message having the same type field value, and an IP address field.

5. The networking auto configuration method of claim 4, wherein the message identification field value includes a randomly selected value and an MAC address of a wireless terminal generating the IP auto setting message.

6. The networking auto configuration method of claim 3, wherein the wireless terminal mode information table includes indexes having values corresponding to the IP address and an operation mode value of a wireless terminal having each IP address.

7. The networking auto configuration method of claim 6, further comprising the step of:
at the mesh router, changing an operation mode by searching an index corresponding to an IP address of the wireless terminal if the mesh router receives the active mesh mode change message or the passive mesh mode change message from the wireless terminal.

8. A virtual link setting method in a multi-hop wireless mesh network including a mesh router supporting an infrastructure mode and an Ad Hoc mode and wireless terminals capable of communicating with the mesh router using an infrastructure mode and forming a network using Ad Hoc mode, comprising the steps of:
at a source terminal, generating a virtual link request message according to a virtual link setting request and transmitting the generated virtual link request message to adjacent nodes;
at a node receiving the virtual link request message, determining whether an entry having a virtual link identifier identical to a virtual link identifier in the received virtual link request message is in a virtual link information table or not;
removing the received virtual link request message if the identical entry is in the virtual link information table;
adding a new entry into the virtual link information table and retransmitting the virtual link request message to adjacent nodes if the identical entry is not in the virtual link information table and if a destination is not oneself;
generating a virtual link response message and transmitting the virtual link response message to adjacent nodes if the identical entry is not in the virtual link information table and if the destination is oneself;
at a node receiving the virtual link response message, determining whether an entry having a virtual link identifier identical to that in the received virtual link response message is in the virtual link information table or not;
comparing a quality of link (QoL) in the virtual link response message with a QoL of an entry stored in the virtual link information table if the identical entry is in the virtual link information table;
removing the received virtual link response message if the QoL of the entry stored in the virtual link information able is better according to the comparison result;
removing the entry of the virtual link information table if the QoL of the virtual link response message is better according to the comparison result, and adding an entry as information of the virtual link response message;
adding a new entry in the virtual link information table if the identical entry is not in the virtual link information;
retransmitting the virtual link response message to adjacent nodes if a destination IP address is different from an own IP address after the adding of the new entry;
after the adding of the new entry, removing the virtual link response message if the destination IP address is identical to the own IP address and terminating virtual link setting.

9. The virtual link setting method of claim 8, further comprising the step of:
at a node receiving the virtual link response message, updating a QoL value of the received virtual link response message before the determining of whether an entry having a virtual link identifier identical to that in the received virtual link response message is in the virtual link information table.

10. The virtual link setting method of claim 9, wherein in the step of updating the QoL value, a QoL value of the virtual link response message is compared with a QoL value at a time of receiving the virtual link request message, and a smaller QoL value is stored as a QoL value of the virtual link response message.

11. The virtual link setting method of claim 8, wherein the virtual link request message and the virtual link response message includes a type field for denoting a type of a message, a length field for indicating a length of a message, a TTL/hop field for expressing the number of hops to transmit a message and the number of hops passed, a quality of link (QoL) field, a virtual link identifier field, a source terminal IP address field, and a destination terminal IP address field.

12. The virtual link setting method of claim 11, wherein the virtual link identifier field includes a randomly selected value and an MAC address of a terminal generating the virtual link request message.

13. The virtual link setting method of claim 8, wherein the virtual link information table includes a destination IP field, a virtual link identifier field, a next hop MAC address field, a hop field for expressing the number of hops to a final destination terminal indicated by the destination IP field, a quality of link (QoL) field, and an expires field for denoting a valid time of a routing path.

14. The virtual link setting method of claim 12, wherein the virtual link identifier is generated by a terminal generating the virtual link request message and all of terminals forming a virtual link store the same virtual link identifier value.

15. The virtual link setting method of claim 13, wherein in order to add new entry to the virtual link information table in the adding of the new entry, a virtual link identifier included in the virtual link request message is stored in a virtual link identifier of the virtual link information table, the expires field is set with a default value, and the destination IP field, the next hop MAC address field, the hop field, and the QoL field in the virtual link information table are set with 0.

16. The virtual link setting method of claim 8, wherein in order to retransmit the virtual link request message in the step of adding the new entry, the TTL field value of the virtual link request message is reduced by 1, the hop field value of the virtual link request message increases by 1, and the virtual link request message to the adjacent node if the TTL field value is not 0.

17. The virtual link setting method of claim 8, wherein a QoL value of a virtual link is calculated using equation:
$$\frac{{QoL}^{α}}{Hop} ,$$
where QoL denote a QoL value and α denotes a weight, and the calculated QoL value of the virtual link is compared.

18. The virtual link setting method of claim 13, wherein in the adding of the new entry, an source IP address of the virtual link response message is stored in a destination IP field of the virtual link information table, a transmitter MAC address of an Ethernet header is stored in the next hop MAC address of the virtual link information table, and a hop value and a QoL value in the virtual link response message are stored in a hop field and a QoL field of the virtual link information table.

19. The virtual link setting method of claim 8, wherein in order to retransmit the virtual link response message to adjacent nodes in the retransmitting of the virtual link response message, the TTL value of the virtual link response message is reduced by 1, the hop value of the virtual link response message increases by 1, and the virtual link response message is transmitted to the adjacent node if the TTL value is not 0.

20. A packet transmitting method in a multi-hop wireless mesh network including a mesh router supporting an infrastructure mode and an Ad Hoc mode and wireless terminals capable of communicating with the mesh router using an infrastructure mode and forming a network using Ad Hoc mode, comprising the steps of:
at a transmitting terminal, searching an entry having a value identical to an IP address of a destination terminal in a data packet from a destination IP field of the virtual link information table;
transmitting a virtual link request message to the destination terminal if the entry is not searched, and setting a virtual link by receiving a virtual link response message from the destination terminal;
composing a virtual link header by copying a virtual link identifier of an searched entry into a virtual link identifier field of a virtual link header of the data packet if the entry is searched, and transmitting a data packet to adjacent nodes;
at an adjacent node receiving the data packet, confirming whether an entry identical to a virtual link identifier of the received data packet is in the virtual link information table if a destination IP address is difference from an IP address of the adjacent node;
removing the received data packet if the identical entry is not in the virtual link information table;
updating a TTL value and a hop in the virtual link header if the identical entry is in the virtual link information table, and transmitting the virtual link header to a next hop node;
at an adjacent node receiving the data packet, generating a virtual link response message having a destination as the transmitting terminal that transmits the data packet to an adjacent node if a destination IP address is identical to an IP address of the adjacent node and if a quality of link (QoL) value of a virtual link header is smaller than a predetermined threshold value; and
transferring a received data packet to a network layer after the generation of the virtual link response message.

21. The packet transmitting method of claim 20, wherein the transmitting of the virtual link request message includes the steps of:
at a node receiving the virtual link request message, removing the received virtual link request message if an entry having a same virtual link identifier is in a virtual link information table;
at a node receiving the virtual link request message, adding a new entry to the virtual link information table and retransmitting the virtual link request message to adjacent nodes if an entry having a same virtual link identifier is not in the virtual link information table and if a destination is not the node itself;
generating a virtual link response message and transmitting the generated virtual link response message to an adjacent node if the destination is the node itself;
at the node receiving the virtual link response message, comparing a quality of link (QoL) in the virtual link response message with a QoL of an entry stored in the virtual link information table if an entry having the same virtual link identifier is in the virtual link information table;
removing the received virtual link response message if the QoL of the entry stored in the virtual link information table is better;
removing the entry of the virtual link information table and adding an entry with information of the virtual link response message if the QoL of the virtual link response message is better;
adding a new entry to the virtual link information table if the same entry is not in the virtual link information table;
retransmitting the virtual link response message to adjacent nodes if a destination IP address is different from an own IP address; and
removing the virtual link response message and setting a virtual link if a destination IP address is identical to an own IP address.

22. The packet transmitting method of claim 21, wherein the transmitting of the virtual link request message further includes:
at a node receiving the virtual link response message, updating a QoL value of the received virtual link response message.

23. The packet transmitting method of claim 22, wherein in the updating of the QoL value, a QoL value of the virtual link response message is compared with a QoL value at a time of receiving the link request message, and a smaller QoL value is stored as a QoL value of the virtual link response message.

24. A wireless terminal capable of communicating with a mesh router supporting an infrastructure mode and an Ad Hoc mode using an infrastructure mode and of forming a network using an Ad Hoc mode, comprising:
a layer 3 adaptation means for transmitting and receiving an Internet protocol (IP) packet to/from a network layer;
a routing message generation means for generating a virtual request message if a virtual link setting request from the layer 3 adaptation means, and generating the virtual link response message according to a request of transmitting the virtual link response message;
a virtual link information storing means for storing a virtual link information table;
a layer 2 adaptation means for transmitting and receiving the virtual link request message and the virtual link response message to/from a data link layer;
a routing message processing means for updating the virtual link information table by processing a virtual link request message received by the layer 2 adaptation means, performing necessary operation to retransmit the virtual link request message to adjacent nodes if an destination IP address of the virtual link request message is not an own IP address, and requesting the routing message generation means to generate the virtual link response message if an destination IP address of the virtual link request message is an own IP address; and
a data relay means for composing a virtual link header by confirming a virtual link identifier of a destination terminal through the virtual link information table if a data packet relay request is received through the layer 3 adaptation means, transmitting the data packet through the layer 2 adaptation layer, performing a necessary operation to retransmit the received data packet to adjacent nodes if a destination IP address of a data packet received through the layer 2 adaptation means is not an own IP address, and transferring a data packet to a network layer through the layer 3 adaptation means if the destination IP address of the received data packet is an own IP address.

25. The wireless terminal of claim 24, further comprising:
an IP address setting means for selecting one of IP addresses used in a mesh network, transmitting an IP auto setting message to adjacent nodes, and setting the selected IP address as an own IP address if an IP conflict message is not received for a predetermined time.

26. The wireless terminal of claim 24, wherein the virtual link request message and the virtual link response message includes a type field for denoting a type of a message, a length field for indicating a length of a message, a TTL/hop field for expressing the number of hops to transmit a message and the number of hops passed, a quality of link (QoL) field, a virtual link identifier field, a source terminal IP address field, and a destination terminal IP address field.

27. The wireless terminal of claim 26, wherein the virtual link information table includes a destination IP field, a virtual link identifier field, a next hop MAC address field, a hop field for expressing the number of hops to a final destination terminal indicated by the destination IP field, a quality of link (QoL) field, and an expires field for denoting a valid time of a routing path.

28. The wireless terminal of claim 24, wherein the routing message processing means removes the received virtual link request message if an entry having a value identical to a virtual link identifier of the virtual link request message is in the virtual link information table, and adds an new entry to the virtual link information table and retransmits the virtual link request message if an entry having a value identical to a virtual link identifier of the virtual link request message is not in the virtual link information table.

29. The wireless terminal of claim 24, wherein the routing message processing means removes the received virtual link response message if an entry having a value identical to a virtual link of the virtual link response message is in the virtual link information table and if a QoL of an entry stored in the virtual link information table is better than a QoL of the received virtual link response message, and removes the entry of the virtual link information table and adds an entry as information of the virtual link response message if a QoL of the received virtual link response message is better than a QoL of an entry stored in the virtual link information table.

30. The wireless terminal of claim 24, wherein the routing message processing means compares a QoL value of the virtual link response message with a QoL value at a time of receiving the virtual link request message, and a smaller QoL value is stored as a QoL value of the virtual link response message.

31. The wireless terminal of claim 24, wherein the data relay means requests the routing message generation means to generate a virtual link response message if a QoL value of a virtual link header of the received data packet is smaller than a predetermined threshold.
